(19) United States
(12) Patent Application Publication
(10) Pub. No.: US 2026/0370256 A1
(43) Pub. Date: Nov. 19, 2026

(54) POSITIONING USING A POSITIONING REFERENCE SIGNAL TRANSMISSION EMPLOYING A FREQUENCY-HOP PATTERN

(71) Applicant: Sony Group Corporation, Tokyo (JP)

(72) Inventors: Basuki PRIYANTO, Lund (SE); Yujie ZHANG, Lund (SE); Anders BERGGREN, Lund (SE)

(21) Appl. No.: 19/111,429

(22) PCT Filed: Sep. 26, 2023
(86) PCT No.: PCT/EP2023/076548

§ 371 Date: Mar. 13, 2025

(30) Foreign Application Priority Data
Sep. 30, 2022 (SE) 2251132-3

(51) Int. Cl. H04B 1/7143; H04L 5/00; H04W 64/00

(52) U.S. Cl. CPC H04B 1/7143; H04L 5/0048; H04W 64/00

(57) ABSTRACT

A repetitive transmission (300) of reference signals for positioning a wireless terminal employs multiple sub-bands (311, 312, 313, 314) that are partly overlapping (321).

### TECHNICAL FIELD

Various aspects of the disclosure pertain to techniques related to positioning of wireless terminals that are connectable to a cellular network. Various examples specifically relate to techniques related to positioning of wireless terminals that have a limited device bandwidth.

### BACKGROUND

To facilitate positioning of wireless communication devices (sometimes also referred to as user equipment, UE), multilateration and multiangulation techniques can be employed. An example of multiangulation is triangulation. Here, multiple (e.g., three) access nodes (ANs, may be also referred to as base stations, BSs, in a cellular network, NW)—having a well-defined position in a reference coordinate system—transmit reference signals (RSs) for positioning (P-RSs). A UE can receive the P-RSs and then trigger a multilateration or multiangulation for UE positioning estimation. This is a scenario which corresponds to a transmission of downlink P-RSs; also, similar concept can also be applied in uplink direction where positioning based on uplink P-RSs is known.

For instance, positioning procedures are available when communicating according to the Third Generation Partnership Project (3GPP) 5G New Radio (NR) protocol. Here, the positioning procedure is supported by the transmission Positioning Reference Signal (PRS), Sounding Reference Signal (SRS) for downlink and uplink-based positioning, respectively). PRS and SRS are, accordingly, example implementations of the P-RS.

According to 3GPP NR protocol—see 3GPP Technical Specification (TS) 37.355 V17.0.0 (2022 March)—, the PRS can be allocated at any physical resource block (PRB) within a system bandwidth and the bandwidth can be configured from 24 PRBs to 276 PRBs in steps of 4 PRBs. The equivalent maximum bandwidth is around 100 MHz—for the case of 30 kHz sub-carrier spacing (SCS)—and around 400 MHz—for the case of 120 KHz SCS. Some UEs are designed to receive the PRS across the carrier band/system bandwidth. I.e., a device bandwidth of these UEs covers the system bandwidth. Such UEs will be referred to as wideband UEs hereinafter.

Also, some types of UEs do not support reception of PRS or other P-RS across the entire carrier band. Such UEs can only monitor a relatively narrower bandwidth or a fraction of system bandwidth, if compared to the wideband UEs. Such UEs will be referred to as bandlimited UEs hereinafter.

In 3GPP NR rel. 17 (see TS 38.300 v17.0.0 (2022 March)), a new UE type has been introduced and called as reduced capability (Redcap) UE. This is an example of a bandlimited UE. The main properties of a RedCap UE is as follows: Reduced maximum device bandwidth: Maximum device bandwidth of a frequency range 1 (FR1) RedCap UE during and after initial access is 20 MHz. Maximum device bandwidth of a frequency range (FR2) RedCap UE during and after initial access is 100 MHz. Thus, in case of FR1, the RedCap device bandwidth is significantly reduced from 100 MHz to 20 MHz, i.e., is significantly lower than the system bandwidth. The RedCap UE can only receive and perform positioning measurement based on a portion (i.e., max 20 MHz) of the system bandwidth. This will significantly reduce the positioning accuracy of a RedCap UE.

Techniques are known in the art to mitigate the reduced device bandwidth of the bandlimited UEs. For instance, WO 2022/036585 A1 discloses a UE measuring, at a first hop of a frequency-hopping scheme, a reference signal on a first sub-band of an effective reference signal bandwidth and measuring, at a second hop of the frequency-hopping scheme, the reference signal on a second sub-band of the effective reference signal bandwidth, the first and second sub-bands of the effective reference signal bandwidth overlapping in part. This enables that the UE estimates a phase difference associated with the first and second hops and compensates for the estimated phase difference on the reference signals as measured on the first and/or second sub-bands of the effective reference signal bandwidth. Further prior art documents are WO 2022/076086 A1 and US 2019/253282.

Such techniques have certain disadvantages. For instance, the configuration and signaling associated with the sub-bands of the frequency-hopping pattern can be comparatively static and cause significant control signaling overhead.

### SUMMARY

Accordingly, there is a need for advanced techniques of facilitating positioning of UEs that have a comparatively limited device bandwidth, specifically of bandlimited UEs that have a device bandwidth that is smaller than a system bandwidth. A need exists for advanced techniques that overcome or mitigate at least some of the above-identified restrictions and drawbacks.

This need is met by the features of the independent claims. The features of the dependent claims define embodiments.

Hereinafter, techniques are disclosed for allocating time-frequency resources to P-RSs in a certain manner so that bandlimited UEs can monitor for the P-RSs or transmit the P-RSs employing these time-frequency resources. The transmission of the P-RSs employs a frequency-hopping pattern including multiple sub-bands. The multiple sub-bands overlap in frequency domain. This enables the UE to form a virtual wideband by stitching together measurements taken on the multiple sub-bands and compensating for phase offsets. Phase offsets can be compensated for by comparing the received phases of P-RSs in different sub-bands in the respective overlap regions. The overlap region, in other words, is used for the calculation/estimation of the phase discontinuities/phase errors that can occur between the hopping, due to radio-frequency hardware retuning at the bandlimited UE.

According to examples, one or more configurations of one or more repetitive transmissions of P-RS are obtained at a wireless communication node.

The wireless communication node can be implemented by a UE or a base station of a cellular network or a location management server of the cellular network.

Obtaining the one or more configurations can include loading the one or more configurations from a local memory, e.g., in case the one or more configurations are preconfigured, e.g., in accordance with a communication protocol.

Obtaining the one or more configurations can include obtaining a control message from another wireless communication node, e.g., via a radio link, the control message being indicative of the one or more configurations.

The one or more repetitive transmissions can include a first transmission that employs a frequency-hop pattern that includes multiple sub-bands.

The one or more repetitive transmissions can include a second transmission. A bandwidth of a wideband employed by the second transmission can be wider than a bandwidth of each one of the multiple sub-bands.

The sub-bands can be arranged with an overlap in the frequency domain. I.e., the multiple sub-bands can be pairwise partly overlapping in frequency domain. This means that pairs of the multiple sub-bands can be allocated to common frequencies, i.e., an overlap region in frequency domain.

The first transmission can include multiple respective repetitions offset in time domain by, e.g., multiple time slots or subframes.

The second transmission can include multiple respective repetitions offset in time domain by, e.g., multiple time slots or subframes.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a transmission of P-RSs according to various examples.

FIG. 2 schematically illustrates positioning of a UE using multiple transmissions from multiple base stations of a cellular network according to various examples.

FIG. 3 schematically illustrates a wideband transmission of P-RSs and a bandlimited transmission of P-RSs, the bandlimited transmission employing a frequency-hop pattern that includes multiple sub-bands according to various examples.

FIG. 4 schematically illustrates a communication node such as a UE or a BS according to various examples.

FIG. 5 is a flowchart of a method according to various examples.

FIG. 6 schematically illustrates a wideband transmission of P-RSs and a bandlimited transmission of P-RSs, the bandlimited transmission employing a frequency-hop pattern that includes multiple sub-bands according to various examples.

FIG. 7 schematically illustrates a muting pattern for muting repetitions of a bandlimited transmission of P-RSs according to various examples.

FIG. 8 schematically illustrates reception of fractions of a wideband transmission of P-RSs at a UE according to various examples.

FIG. 9 is a signaling diagram of communication between a UE, BS, and a location management server according to various examples.

FIG. 10 is a flowchart of a method according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the invention will be described in detail with reference to the accompanying drawings. It is to be understood that the following description of examples is not to be taken in a limiting sense. The scope of the invention is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques which facilitate positioning of UEs are described. Positioning allows determining the geographic position and/or velocity of the UE based on measuring the received UL and/or DL P-RSs. Location/Position estimates of the UE may be requested by and reported to a client (e.g., an application) associated with the UE, or by a client within or attached to a core network of a cellular network (NW). The location estimates may be reported in standard formats, such as those for cell-based or geographical co-ordinates, together with estimated errors (uncertainty) of the position and velocity of the UE and, if available, the positioning method (or the list of the methods) used to obtain the position estimate.

There are many different possible use cases for location estimates. The positioning estimates may be used internally by communication systems, such as 3GPP Long Term Evolution (LTE) cellular NWs or 5GNR cellular NWs, by value-added network services, by the UE itself or through the network, and by “third party” services. The functions may also be used by an emergency service, but the location service is not exclusively for emergencies.

The techniques disclosed herein can be generally applied to various kinds and types of cellular NWs. However, hereinafter, reference will be made to 3GPP specified cellular NWs, for illustrative purposes. Specifically, reference will be made to 3GPP NR cellular NWs.

The techniques described herein generally rely on transmissions of P-RSs. Various implementations of P-RSs are conceivable. For example, P-RSs may be transmitted in the DL (e.g., 3GPP PRS, 3GPP CSI-RS) or in the UL (e.g., 3GPP SRS). According to the disclosure, DL-based positioning and/or UL-based positioning can be used. For DL positioning: The DL P-RSs are transmitted by multiple BSs or transmission and reception points, TRPs, (e.g., gNBs for 3GPP NR) and can be received by a target UE to be positioned. On the other hand, for the UL positioning, the UL RSs—e.g., SRSs—are transmitted by the target UE to be positioned and can be received by multiple BSs or TRPs.

The P-RS can be broadcasted. Cell-specific P-RS can be employed. Resources can be allocated to a transmission of P-RS that support multiple beams. For instance, P-RSs could be arranged in an interleaved pattern (e.g., comb-N pattern) multiplexed with different transmit-receive points (TRPs) of a BS. The P-RS from a TRP is transmitted in every Nth sub-carrier and be interleaved with the P-RS from other TRPs. Here, a UE can perform positioning measurements on multiple TRPs simultaneously.

Hereinafter, various examples will be specifically made in the context of an implementation of the P-RS by PRS. However, it should be understood that the respective techniques can also be applied to different kinds and types of P-RS in other scenarios.

Next, some examples with respect to the transmission of PRS will be disclosed, as well as in connection with the signal design of the PRS.

Transmission of PRS is defined per-resource. A set of PRS resources is called PRS resource set. Within a PRS resource set, each resource can represent the transmission in different beam (also known as spatial filter) and/or repeated transmission. The PRS resource set can be repeated with a periodicity of 4 ms to 10.24 sec. Thus, according to examples, a repetitive transmission of PRS is employed. A collection of PRS resource sets with the same PRS characteristics, e.g., sub-carrier spacing (SCS), Cyclic Prefix (CP), PRS Reference Point, is called PRS frequency layer.

PRS signal is generated with a gold sequence generator as described in 3GPP Technical Specification (TS) 38.211, Version 17.1.0, section 7.4.1.7. The PRS signal is placed in a NR resource block, in certain time-frequency resource elements (RE), such that in certain sub-carrier k and Orthogonal Frequency Division Multiplex (OFDM) symbol L PRS is allocated with a certain comb-structure. K_comb=4 means the PRS is allocated every fourth sub-carrier k.

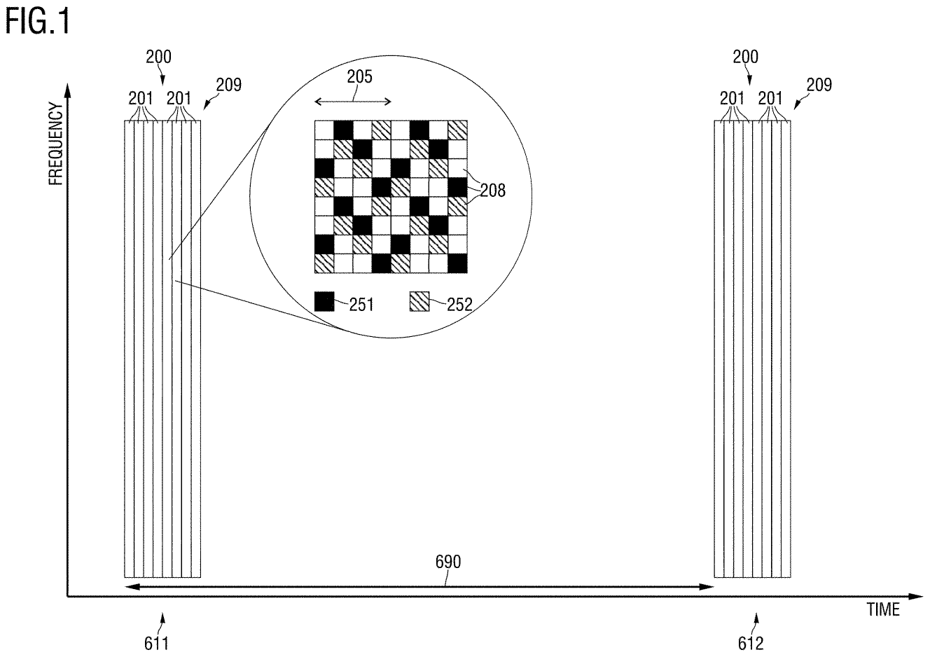

The PRS transmission 200, resource allocation and transmission/reception are illustrated in FIG. 1. FIG. 1 illustrates PRS resource sets 201 of the PRS transmission 200 (in the illustrated example, the PRS transmission 200 includes seven PRS resource sets 201).

The PRSs are allocated with a certain wideband 209. The wideband 209 can cover the entire maximum carrier bandwidth of the carrier, i.e., the system bandwidth (the system bandwidth can be smaller than the maximum carrier bandwidth specified in the communication protocol, e.g., in 3GPP NR 100 MHz for Frequency Range 1 and 400 MHz for Frequency Range 2). The PRS transmission 200 will thus be referred to PRS wideband transmission 200, or simply wideband 20 transmission 200. A PRS resource includes multiple PRBs. Each PRB includes multiple time-frequency resource elements 208 (cf. inset of FIG. 1). The inset of FIG. 1 shows the comb structure of PRS transmission within a PRB, i.e., the comb size 205 specifying the time-frequency domain density of the time-frequency resource elements 208 allocated to the PRS transmission (in the illustrated example, the comb size 205 is four). Two PRSs 251, 252 with different offsets are allocated 25 for two TRPs/gNBs in the example of FIG. 1.

The wideband transmission 200 is repetitive. Illustrated are two repetitions 611, 612 of the wideband transmission 200. The periodicity 690 is illustrated. This enables the UE to monitor for the PRS 251, 252 multiple times, which facilitates increased positioning accuracy and/or enables the UE to monitor for the PRS 251, 252 in different time occasion.

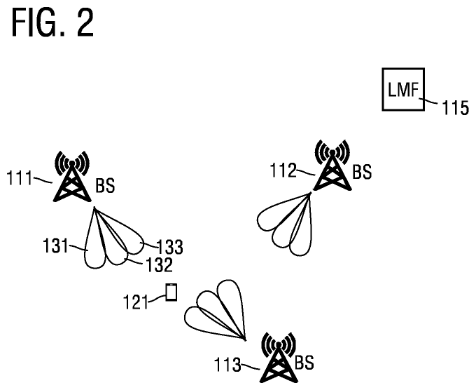

Referring to FIG. 2, a PRS resource set 201 typically corresponds to a PRS transmission with a certain beam 131, 132, 132. The UE 121 is expected to measure multiple PRS resources from multiple BSs 111, 112, 13. The UE 121 reports the best beam (e.g., represented in the PRS resource ID) and the timing measurements to a location management server, e.g., the location management function (LMF) 115 in the 3GPP NR implementation. Hence, the LMF can perform 35 multilateration for positioning estimation.

Bandlimited UEs are not able to monitor for the PRS 251, 252 across the entire wideband 209. It is now assumed that the UE 121 is a bandlimited UE. Bandlimited UEs can only monitor a fraction of wideband 209 which may reduce the positioning estimation accuracy.

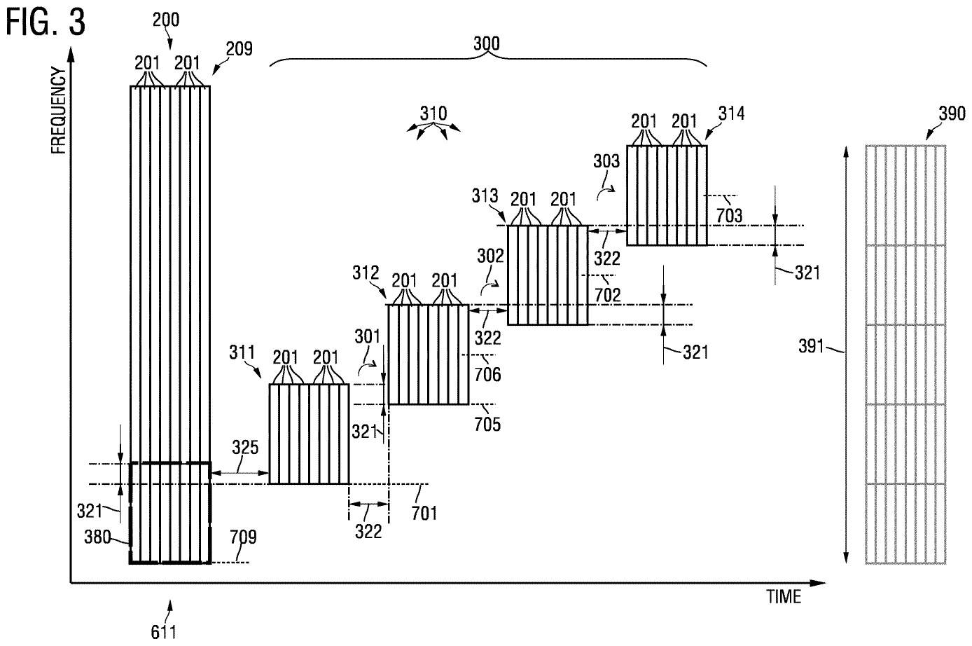

To mitigate this, according to examples, a frequency-hop pattern including multiple-sub-bands is employed. This is illustrated in FIG. 3.

FIG. 3 illustrates that the wideband transmission 200 (on a wideband 209) coexists with a bandlimited transmission 300. The bandlimited transmission 300 employs multiple sub-bands 311, 312, 313, 314 that are arranged in a frequency-hop pattern 310. This is a transmit frequency-hop pattern 310 employed by the BSs 111, 112, 113 for transmitting the PRSs 251, 252. The respective frequency hops 301, 302, 303 are illustrated. The UE 121 measures (i.e., attempts to receive PRS 251, 252/monitors for PRS 251, 252), accordingly, on the sub-bands 311 prior to measuring on the sub-band 312.

Each one of the sub-bands 311, 312, 313, 314 has a respective bandwidth that is smaller than the bandwidth of the wideband 209. Thus, the bandlimited receiver of the bandlimited UE 121 is enables to receive signals on the sub-bands 311, 312, 313, 314. The bandwidth or bandwidths of the sub-bands 311, 312, 313, 314 are matched to the device bandwidth of the bandlimited UE 121.

To compensate for phase errors (every time a phase locked loop is switched to another frequency, a random phase error is introduced at the UE), there are overlap regions 321 in frequency domain where the multiple sub-bands overlap. Because the sub-bands are pairwise partly overlapping in frequency domain, the UE 121 can estimate the phase offset by comparing a phase of the received PRS in a first sub-band on a given frequency with the phase of a received PRS on a second sub-band on the same given frequency, in the overlap area. This enables the UE 121 to form a virtual wideband 390. Measurements are obtained throughout a bandwidth 391 of the virtual wideband 390. This corresponds to stitching multiple sub-bands.

Pairwise partly overlapping in frequency domain can mean that to sub-bands are different from each other, but have an overlap region in the frequency domain. For instance, sub-band A may span from frequency A to frequency B, and sub-band B may span from frequency B-d to frequency C. The overlap is d. Typically d is much smaller than the distance from A to B and the distance from B-d to C.

According to examples, the BS transmits one or more PRSs in different sub-bands, one after another. The UE monitors for the one or more PRSs in the sub-bands individually. The UE combines the measurements on the one or more PRS in the sub-bands.

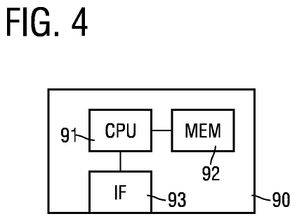

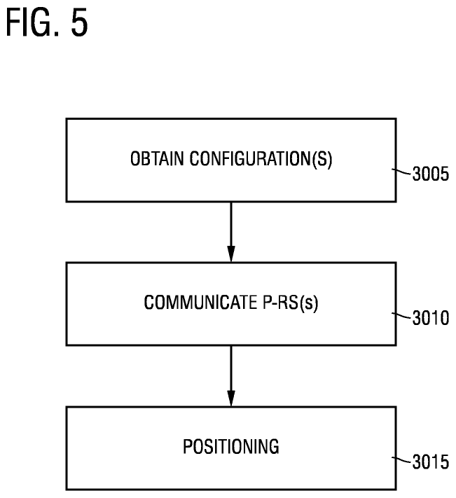

This is the framework which significantly mitigates the performance loss of bandlimited UEs. For example, by stitching PRS measurements taken in five different 20 MHz sub-bands, the bandlimited UE can achieve a similar performance as a wideband UE that monitors for PRSs in a 100 MHz wideband. Further details of FIG. 3, beyond this framework of using multiple sub-bands for PRS transmission will be explained below, also with reference to FIG. 4 and FIG. 5.

FIG. 4 schematically illustrates a communication node 90 according to various examples. For instance, the communication node 90 could implement a bandlimited UE such as the UE 121 (cf. FIG. 2). It would also be possible that the communication node 90 implements a BS, e.g., one of the BSs 111, 112, 113 that transmit the positioning reference signals 251, 252 (cf. FIG. 2).

The communication node 90 includes a processor 91 and a memory 92. The communication node 90 also includes an interface 93. Using the interface 93, the communication node 90 can communicate wirelessly with further communication node, using a wireless carrier, e.g., using Orthogonal Frequency Division Multiplex modulation. The processor 91 can load program code from the memory 92 and execute the program code. The processor 91, upon loading and executing the program code, can perform techniques as disclosed herein, e.g.: obtaining a configuration of one or more repetitive transmissions of P-RS, e.g., PRS or SRS; transmitting and/or receiving the P-RS in accordance with the configuration; participating in a positioning procedure for positioning a UE; etc.

FIG. 5 is a flowchart of a method according to various examples. For example, the method of FIG. 5 can be executed by a communication node, e.g., a UE or a BS of a cellular network. For example, the method of FIG. 5 could be executed by the UE 121 of FIG. 2 or it could be executed by a BS such as the BS 111 or the BS 112 or the BS 113. Alternatively, BSs can be configured and provide the configuration to LMF. Later, LMF provides the configuration to the UE. The method of FIG. 5 could be executed by the processor 91 upon loading and executing program code from the memory 92 (cf. FIG. 4).

At box 3005, a configuration or multiple configurations are obtained. The configuration or the multiple configurations are for one or more repetitive transmissions of PRS. For instance, a configuration that jointly defines a bandlimited transmission and a wideband transmission can be obtained. It would also be possible to obtain multiple configurations, one for a bandlimited transmission and a further configuration for a wideband transmission.

Example parameters that can be set by the configuration include, e.g.: number of resource sets per frequency layer; number of PRBs; frequency-hop pattern; comb structures; sequence design of PRS; timing of repetitions of the respective transmission; etc.

As a general rule, obtaining a configuration can pertain to loading the configuration from a memory. For instance, the configuration may be predefined according to a communication protocol such as 3GPP 5G NR. Obtaining the configuration may, alternatively or additionally, include receiving a configuration message that is indicative of at least a part of the configuration from another communication node. For instance, at least parts of the configuration may be determined at a BS of a cellular NW and then provided, by using a respective configuration message, to one or more UEs that are served by that BS. For instance, a Radio Resource Control (RRC) control message may be used to provide the configuration(s). Obtaining a configuration can include determining/generating the configuration. For instance, the BS can determine a configuration and then provide, using a respective control message, the configuration to a UE. In another example, at least parts of the configuration may be determined at a LMF of a cellular NW and then provided, by using a respective configuration message, to one or more UEs via one of the BS. For instance, a LTE positioning protocol (LPP) message may be used to provide the configuration(s).

At box 3010, PRS are then communicated in accordance with the one or more configurations obtained at box 3005. The PRS transmission or transmissions are executed.

Box 3010 can include transmitting the one or more PRSs in accordance with the configuration. Box 3010 can include implementing one or more repetitions of a transmission of the PRSs in accordance with the configuration. Box 3010 can include attempting to receive (monitoring for) PRSs transmitted in accordance with the configuration. For instance, a UE may attempt to receive downlink PRSs and thereby participate in the transmission. The BS can transmit the DL PRSs and thereby participate in the transmission. The UE can implement, at box 3010, one or more positioning measurements and thereby participate in the transmission.

Specifically, at box 3010, the UE can monitor for downlink PRSs on multiple sub-bands of a frequency-hopping pattern. As previously discussed in connection with FIG. 3, the sub-bands are pairwise overlapping (cf. FIG. 3: where the overlap region 321 in frequency domain has been illustrated). Based on receive phases of the PRS received in a first sub-band and in second sub-band, more specifically in the frequency overlap, a phase offset in between the adjacent sub-bands can be estimated and compensated.

At box 3015, positioning of the UE is then facilitated based on the communication of the one or more PRSs at box 3010. The UE can provide a measurement report to the BS or a location management server such as a 3GPP NR LMF (cf. FIG. 2: LMF 115). Multilateration is then possible based on these measurement reports.

Next, various example implementations of box 3005 and box 3010 will be explained. For this reference will be made to FIG. 3 and other FIGs.

As illustrated in FIG. 3, coexistence between the wideband transmission 200 and the bandlimited transmission 300 is possible. Specifically, it is possible that the repetitions of the wideband transmission 200 and the repetitions of the bandlimited transmission 300 are interleaved in time domain. This means that it is possible to alternate between the wideband transmission 200 and the bandlimited transmission 300. Thereby, wideband UEs and bandlimited UEs can be both served.

Next, example details with respect to a bandlimited UE 121 reusing a part of the wideband transmission 200, as well as participating in the bandlimited transmission 300 will be disclosed.

In some examples, the UE 121 monitors for the PRSs in a bandlimited fraction 380 of the wideband 209 of the wideband transmission 200. Thus, the overall spectral efficiency can be increased.

In some examples, the configuration can define the bandlimited fraction 380 of the wideband 209 as part of the frequency-hop pattern 310. Thus, the configuration of box 3005 can include the frequency-hop pattern which includes the multiple sub-bands as well as the wideband 209. By defining the bandlimited fraction 380 as part of the frequency-hop pattern, compact control signaling to configure bandlimited UEs is possible. Also, the bandlimited fraction 380 has an overlap region 321 with the sub-band 311, to compensate for phase errors. Thus, legacy transmission of PRSs can be configured as the first hop of the frequency-hop pattern. A bandlimited UE can start using the wideband transmission, so that fewer sub-bands are required. For instance, as illustrated in FIG. 3, there are only four sub-bands 311-314; this is enabled by the UE monitoring the bandlimited fraction 380 of the wideband 209. In an alternative example, the UE would not monitor the bandlimited fraction 380; in such case, it would be possible that the bandlimited transmission 300 includes a frequency-hop pattern 310 that includes a total of five sub-bands, were in the first sub and corresponds to the frequencies covered in FIG. 3 by the bandlimited fraction 380.

Next, example details with respect to the structure of the configuration, e.g., with respect to the information content of respective configuration data, obtained at box 3005 of the method of FIG. 5 will be explained.

According to examples, separate configurations are provided (cf. box 3005 of FIG. 5) for the wideband transmission 200 and the bandlimited transmission 300. This would enable to tailor the properties of the PRS bandlimited transmission 300 to the requirements of bandlimited UEs.

For instance, separate control messages may be used that carry the two configurations for the wideband transmission 200 as well as for the bandlimited transmission 300.

In some examples, different PRS(s) are used for the bandlimited transmission 300 and the wideband transmission 200. For example, one or more PRSs of the bandlimited transmission 300 may have a different transmit power than one or more PRSs of the wideband transmission 200 (e.g., power boosting in bandlimited transmission 300). For instance, the sequence design (e.g., different sequence identity) of the one or more PRSs of the bandlimited transmission 300 may at least partly different from the sequence design of the one or more PRSs of the wideband transmission 200.

As a further example, the comb structure may differ between the bandlimited transmission 300 and the wideband transmission 200.

For instance, the length (number of symbols) of each repetition may differ between the wideband transmission 200 and the bandlimited transmission 300. The number of resource sets may differ.

As a further example, a periodicity of repetitions of the bandlimited transmission 300 is different than (in particular, smaller than) a periodicity of repetitions of the wideband transmission 200. This means that PRS are more often transmitted on the wideband 209 than on repetitions of the sub-bands.

As a further example, different muting patterns may be used.

It is, as a general rule, also possible that the bandlimited transmission 300 and the wideband transmission 200 are configured use at least partly the same parameters. In such a scenario, it would be possible to implement a joint configuration, e.g., using a single configuration message.

In examples, a common configuration is provided for, both, the wideband transmission 200, as well as the bandlimited transmission 300. The configuration can jointly set one or more values of one or more parameters of, both, the wideband transmission 200 as well as the bandlimited transmission 300. This can reduce control signaling overhead, because fewer information elements are required to configure the bandlimited transmission 300 and the wideband transmission 200.

Above, examples of parameters for which different values can be used for the bandlimited transmission 300 and the wideband transmission 200 have been disclosed. In other examples, for such parameters the same values can be used for the bandlimited transmission 300 and the wideband transmission 200. Examples of parameters that can be jointly set include a subcarrier allocation of the PRS 251, 252, i.e., a comb structure. Further examples include a sequence design of the PRS 251, 252. The same sequence ID may be used. It would be possible that the same muting patterns are used. The same repetition periodicity may be used. Further examples include one or more resource sets, i.e., the same count of resource sets may be used.

The size (i.e., number of PRB) for each sub-band 311, 312, 313, 314 be configured for each frequency layer (configurable) or predefined (static). For example, A RedCap UE with 20 MHz bandwidth can in accommodate max 110 RBs for SCS 15 KHz. The RedCap UE can be configured with other number of PRBs (not necessarily 110 RB), particularly to optimize the hopping operation related to the total bandwidth for frequency hopping operation and the overlap BW).

According to examples, the sub-bands 311-314 of the frequency-hop pattern 310 can each have the same bandwidth or varying bandwidth. The bandwidth of the sub-bands 311-314 is defined by the configuration of the bandlimited transmission 300.

The bandwidth of the sub-bands can be smaller than a device bandwidth of the bandlimited UE 121. This enables matching the bandwidth of the sub-bands 311-314 to the size of PRBs and tailoring the respective overlap region 321.

Next, example details with the relationship between the wideband transmission 200 and the bandlimited transmission 300 will be disclosed. Examples will be disclosed how the respective configurations relate to each other.

As a general rule, the bandlimited transmission 300 can have the same properties as the wideband transmission 200. More specifically, it is possible that the PRSs 251, 252 transmitted as part of the bandlimited transmission 300 have the same properties as the PRSs 251, 252 transmitted as part of the wideband transmission 200. Thus, a single configuration for the PRSs can suffice. The signaling is reduced.

For instance, the bandlimited transmission 300 can be configured with the same resource set as the wideband transmission 200. It would also be possible to use a fraction of the resource set of the wideband transmission 200 for the bandlimited transmission 300. For instance, if the resource set of the wideband transmission 200 has eight PRBs allocated to the PRSs 251, 252, then the resource set of the bandlimited transmission 300 can have four PRBs allocated to the PRSs 251, 252. Thereby, the overhead of resource-elements allocated to the PRSs by the BS can be reduced, thereby freeing up resources for other tasks. In practice, N resource blocks of the wideband transmission can be mapped to M resource blocks of the bandlimited transmission 300. I.e., a count of time-frequency resource elements per resource set can be lower for the bandlimited transmission 300 than for the wideband transmission 200.

Specifically, it is possible that the count of time-frequency resource elements per resource set for the bandlimited transmission 300 is a fraction of the respective count for the wideband transmission 200. This fraction can be indicated by the configuration obtained at box 3005 of FIG. 5. For instance, the configuration can indicate the PRBs per resource set for the wideband transmission 200 and further indicate the respective fraction; thereby, the UE 122 can deduce the resource blocks per resource set for the bandlimited transmission 300 from the configuration.

More generally, according to examples, there is a predefined mapping between the count of time-frequency REs per resource set of the wideband transmission to the count of time-frequency REs for a resource set of the bandlimited transmission (or vice versa). This enables the a configuration to explicitly indicate the value for the count of time-frequency resource elements per resource set for the wideband transmission; the UE, employing the predefined mapping, can then reduce/infer of the value for the count of time-frequency resource elements per resource set for the bandlimited transmission 300.

Such mapping also is applicable to other parameters of the bandlimited transmission 300 and the wideband transmission 200, respectively. An example would be the count of resource sets 201.

Thus, in some examples, the configuration explicitly indicates a value of a given parameter for the wideband transmission 200; then, the respective value of the given parameter for the bandlimited transmission 300 is set based on a respective predefined mapping. The mapping can be indicated by the configuration, e.g., can be communicated from the BS to the UE or from the LMF to the UE; alternatively it would be possible that the mapping is specified by a communication protocol used for communicating on the wireless carrier, i.e., is predefined according to the communication standard.

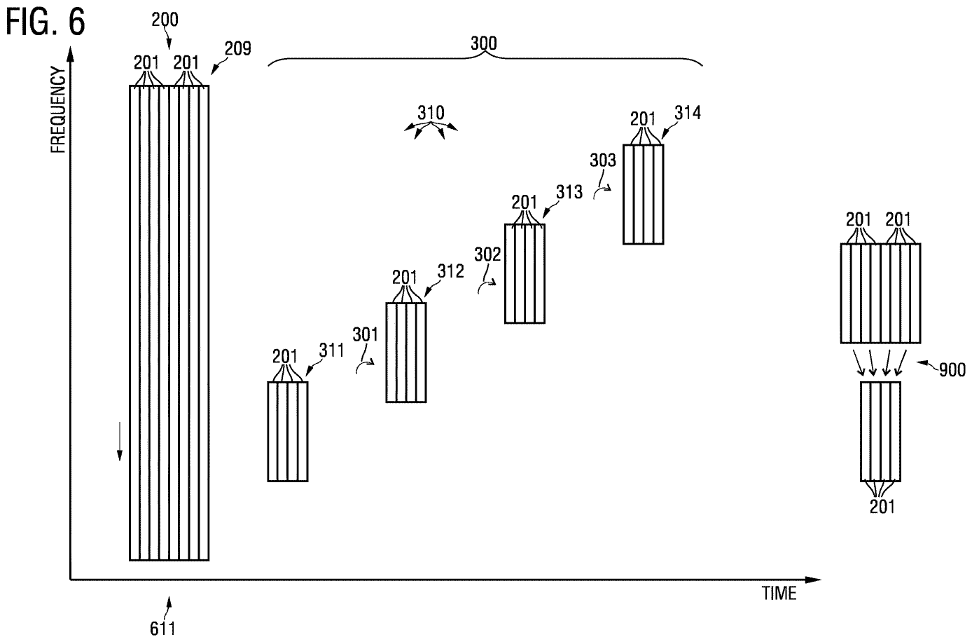

The mapping can be from the wideband transmission 200 to the bandlimited transmission 300, or vice versa. For instance, an example is illustrated in FIG. 6. Here, a mapping 900 (cf. inset of FIG. 6) is defined between the number of resource sets 201 used for the wideband transmission 200 and the bandlimited transmission 300. For instance, the count of resource sets 201 for the bandlimited transmission 300 can be obtained by multiplying the count of resource sets 201 for the wideband transmission 200 by a fraction that is given by the count of PRBs of a repetition of the wideband transmission 200 divided by a count of PRBs of a repetition of the bandlimited transmission 300.

Next, details with respect to the time-domain configuration and relative arrangement of the wideband transmission 200 and the bandlimited transmission 300 are disclosed. Illustrated in FIG. 3 is a time gap 325 between the wideband 209 and the sub-band 311, as well as time gaps 322 between adjacent ones of the sub-band 311-314. In the illustrated example of FIG. 3, these time gaps 322, 325 are all dimensioned alike. Different time gaps can be used depending on the numerology of the PRS transmission.

The duration of a time gap can expressed as a number of slots of the communication protocol. A slot includes a predefined number of symbols of an OFDM modulation.

The configuration can specify one or more such time gaps 322 in between parts of the repetitive transmission 200. Alternatively or additionally, the configuration can specify the time gap 325 in between the wideband transmission 200 and the repetitive transmission 300.

By appropriately configuring the time gaps 322, 325, it is possible to enable the UE 120 121 to retune its RF receiver (or RF transmitter, for UL P-RSs). At the same time, scheduling strategies can be implemented, to accommodate further transmissions different than the wideband transmission in the bandlimited transmission 300.

For example, the time gap 322 and/or the time gap 325 is specified, by the configuration, as a function of the subcarrier spacing of the carrier. For instance, a larger subcarrier spacing (SCS) can have a shorter duration of the time gap 322 and/or of the time gap 325, and vice versa. For example, 15 kHz SCS has 1 time slot and 60 KHz has 4 time slots. By this arrangement, the operation of wideband carrier with multiple numerologies can be properly arranged, such as to obtain time alignment across different transmission with different numerologies. This kind of configuration can be predefined in the specifications. For example, a table representing the time-gap depending on the NR numerology parameter (i.e., SCS). Both UE and BS (implemented by a gNB in 3GPP NR) adopt the configuration accordingly.

The time gaps 322 may be configured as part of the configuration of the frequency-hop pattern 310.

Next, example details with respect to the frequency-hop pattern 310 are disclosed.

The configuration can be indicative of the frequency-hop pattern 310. For instance, the frequency offset between the sub-bands 311, 312, 314, 315 of the various hops with respect to each other or with respect to a common reference frequency can be defined. As illustrated in FIG. 3, it would be possible that the center frequency 706 of the sub-band 312—corresponding to the second hop—is defined with respect to the reference frequency 701 that is defined with respect to the sub-band 311 (lower frequency thereof). Likewise, the center frequency 702 of the sub-band 313 can be defined with respect to the frequency 705, which is the lower frequency of the sub-band 312 of the preceding hop. It would also be possible that a common reference frequency, e.g., the lower edge of the system bandwidth is used to define the frequencies of the sub-bands 311-314.

More generally, the configuration can be indicative of the frequencies (i.e., the frequency range occupied by that sub-band) of a given subagent by indicating a relative frequency shift with respect to a reference frequency, e.g., that is defined with respect to a further sub band or globally defined for all sub-bands alike.

In some examples, the frequency offsets in between adjacent sub-bands 311-314 are uniform. Alternatively, the configuration is indicative of a variation of the frequency offset from subband to sub-band. The relative frequency offset between the hops 301-303 of the frequency-hop pattern 310 can thus be configurable. Such variation of a value of a parameter from sub-band to sub-band is not limited to the frequency offsets. Other parameters that can vary from sub-band to sub-band include the number of time-frequency resources, e.g., PRBs or REs, allocated to the PRS per sub-band, e.g., by defining the number of resource sets 201 and/or by defining the comb structure.

In some examples, the size of overlap region 321 is fixed, e.g., a single PRB or a certain fraction thereof. It would also be possible that the size of the overlap region 321 is varied. For instance, the number of REs defining the overlap region can vary as a function of the comb size and the number of symbols per slot. The configuration can be indicative of the overlap bandwidth (i.e., the frequency-domain extension/size of the overlap region 321) that can be defined based on (i.e., as a function of) the frequency domain density of the time-frequency resource elements allocated to the PRS.

This is based on the following finding: Due to the property of comb structure, the time-frequency REs 208 within the overlapping region 321 may not be fully occupied by the PRS from a given gNB/TRP. Only the occupied REs 208 in the overlap can be effectively used for phase error calibration. The number of effective RE 208 in the overlap can be calculated by:

$${L}_{oRE} = {L}_{oPRB} \times 12 \times \frac{{L}_{PRS}}{{k}_{comb}^{PRS}}$$

Where L_{oRE} is the number of overlap effective resource elements, L_{oPRB} is the number of overlap physical resource block, L_{PRS} is the number of the occupied PRS symbols per slot, and

$${k}_{comb}^{PRS}$$

is the comb size. For DL-PRS configuration, only these

$$\{ {L}_{PRS} , {K}_{c o m b}^{PRS} \}$$

combinations can be selected: {2, 2}, {4, 2}, {6, 2}, {12, 2}, {4, 4}, {12, 4}, {6, 6}, {12, 6} and {12, 12}.

The number of overlapping PRBs L_{oPRB} can be dynamically adapted to ensure the number of effective RE L_{oRE} maintain the same for different comb structures. The following is the table listing all the possible L_{oPRB} in different

$$\{ {L}_{PRS} , {K}_{c o m b}^{PRS} \} .$$

| {L_{PRS}, K_{comb}^{PRS}} | L_{oPRB} (Where N is positive integer) |
|---|---|
| {2, 2}, {4, 4}, {6, 6}, {12, 12} | 6N (6, 12, 18, . . .) |
| {4, 2}, {12, 6} | 3N |
| {6, 2}, {12, 4} | 2N |
| {12, 2} | 1N |

Table 1: The number of overlapping physical resource block L_{oPRB} as a function of

$$\{ {L}_{PRS} , {K}_{c o m b}^{PRS} \}$$

Given the function above, the total amount of overlapping effective RE is always 72N. This helps to reliably compensate for the phase error.

According to examples, the frequency-hop pattern is static. The frequency-hop pattern can be pre-configured. The frequency-hop pattern can be is defined in the specification of the communication protocol (e.g., always four hops at a certain overlap and certain frequencies). Hence, no dedicated signaling is required to signal the respective (part of the) configuration. In other examples, the frequency-hop pattern is configurable: Multiple possible patterns can be predefined. The network (e.g., the LMF 115) inform the UE on the hopping pattern. Thus, it would be possible to provide the configuration that is indicative of one or more values of one or more parameters of the frequency-hop pattern by including a codebook index of a predefined codebook of a plurality of predefined candidate frequency-hop patterns. This reduces the control signaling overhead required to signal the configuration.

The codebook can, accordingly, include multiple entries which are associated with different frequency-hop patterns. By indicating the particular entry of the codebook, a specific frequency-hop pattern can be selected. Next, details with respect to muting repetitions of the bandlimited transmission 300 are disclosed.

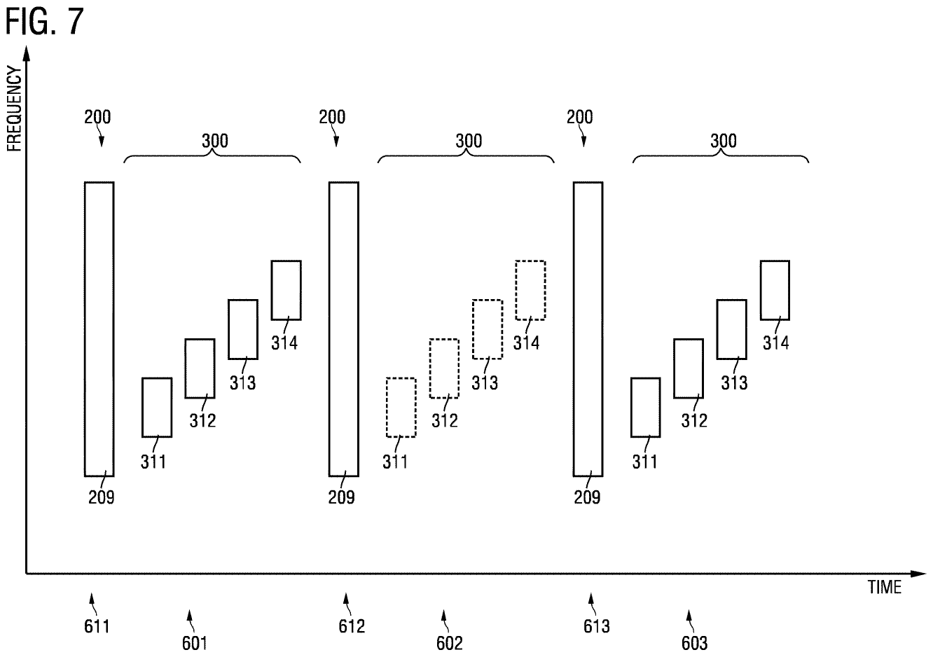

It would be possible that certain repetitions of the bandlimited transmission 300 are muted. This means that the configuration can specify, e.g., periodic repetitions or, more generally, multiple repetitions of the bandlimited transmission 300. Then, after configuring, some of these repetitions are skipped. Thereby, the spectral allocation of PRS can be reduced. The configuration of the bandlimited transmission 300 can, accordingly, specify whether one or more of the multiple repetitions of the bandlimited transmission 300 are muted. This is illustrated in FIG. 7. FIG. 7 illustrates multiple repetitions 601-603 of the bandlimited transmission 300, as well as multiple repetitions 611-613 of the wideband transmission 200.

As a general rule, according to examples, periodic muting is possible. The periodicity of the PRSs being transmitted using the bandlimited transmission 300 can thus be longer than the periodicity of the PRSs being transmitted using the wideband transmission 200. In particular, for RedCap UEs, this can be a feasible option, because a latency requirement associated with the positioning can be relaxed. This can be due to, e.g., reduced mobility of such devices, such as IoT device. Accordingly, the configuration can include a repetitive muting pattern that specifies the periodicity of the muting of the repetitions.

In other examples, the bandlimited transmission can be aperiodically muted. For instance, if the BS requires to use time-frequency resource elements for other transmissions, then, and instance-specific muting command can be provided. Accordingly, the configuration can include an aperiodic muting command that specifies individual repetitions 601, 602, 603 to be muted.

It would also be possible that muting in accordance with a muting pattern is triggered by an aperiodic command. For instance, the muting pattern may specify certain periodicity of muting and this may be preconfigured and subsequently activated by a respective command.

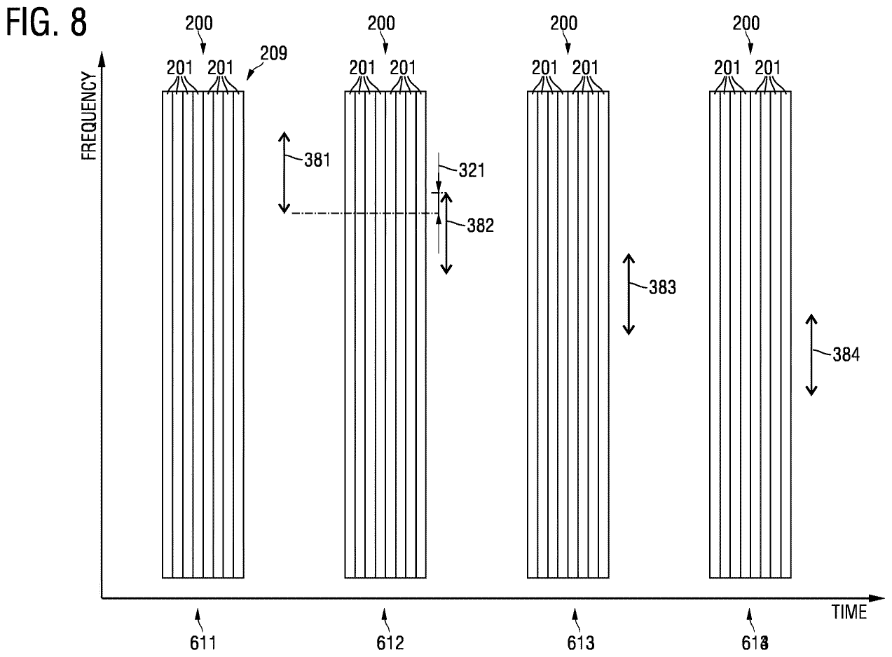

Above, scenarios have been disclosed according to which a transmitter-side frequency-hop pattern is implemented. A transmitter-side frequency hop pattern is not required in all scenarios. For instance, as illustrated in FIG. 8, in other examples, the UE may implement, at the receiver side, a frequency-hop pattern. Here, the wideband transmission 200 is repeated (repetitions 611, 612, 613, 614) and the UE 121 can monitor different fractions 381, 382, 383, 384 of the respective wideband in subsequent repetitions 611, 612, 613, 614. Examples disclosed above with respect to the configuration of the transmitter-side frequency hop pattern 310 are also applicable to the receiver-side frequency-hop pattern, e.g., with respect to the overlap region 321, etc.,

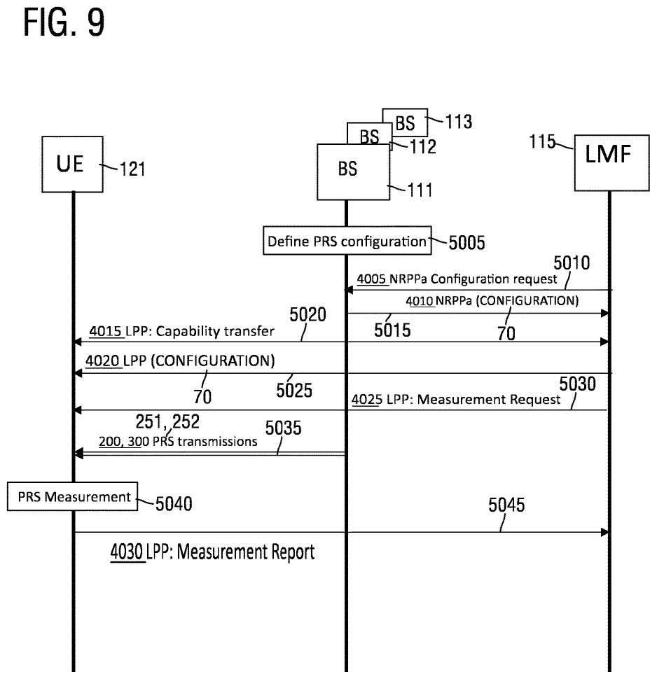

FIG. 9 is a signaling diagram of communication between the bandlimited UE 121, the serving BS 111 and the further BSs 112, 113, as well as the LMF 115.

At box 5005, the serving BS determines the PRS configuration, for, both, the wideband transmission 200, as well as the bandlimited transmission 300. Box 5005, accordingly, implements box 3005, for the BS perspective. In other examples, the PRS configuration is (at least partly) determined at the LMF 115. It would also be possible that at least parts of the PRS configuration are determined at the UE 121.

The BS 111 then provides, at 5015, the configuration 70 to the LMF 115 using a respective positioning protocol control message 4010 which is (optionally) triggered by a respective request 4005 provided by the LMF 152 the BS 111 at 5010.

At 5020, the UE 121 provides its capability or capabilities associated with the monitoring for PRSs in a respective control message 4015 to the LMF 115.

For instance, the UE 121 may indicate whether it can monitor a bandlimited PRS transmission such as the PRS transmission 300 on multiple sub-bands. The UE can indicate whether it can perform a virtual bandwidth calculation, e.g., including compensation for phase offsets based on a phase comparison between PRS received on different sub-bands in the same overlap region. Typically, a higher number of sub-bands will increase the UE complexity. The UE could also indicate that it is not capable of a virtual bandwidth calculation; in which the positioning could be restricted to PRS received on a single sub-band.

In the illustrated case of FIG. 9, the UE 121 is capable of performing a virtual bandwidth calculation; and, accordingly, the LMF 115 provides, at 5025, in a respective control message 4020, the configuration 70 to the UE 121. Thereby, the UE 121 obtains the configuration 70.

This is followed by a measurement request 4025 provided by the LMF 152 the UE 121 at 5030.

Then, one or more PRS (e.g., PRS 251, 252) are transmitted in the respective PRS transmissions 200, 300 at 5035 and the UE monitors for the PRSs 251, 252. Thus, the BS 111 and the UE 121 participate in the PRS transmissions 200, 300. At 5035, it would be possible to transmit multiple repetitions of the respective PRS transmissions 200, 300. The UE 121 implements respective PRS measurements at 5040. The UE implements the PRS measurements on multiple sub-bands of the frequency-hop pattern of the bandlimited PRS transmission 300.

At 5045, the UE then provides a measurement report message 4030 to the LMF 115. This can include a dedicated information element associated with PRS measurements on the bandlimited transmission 300.

Then, the LMF 115 can position the UE.

It is possible that a collision occurs in between the PRS transmissions 200, 300, specifically the bandlimited PRS transmission 300, and a further transmission. Further transmissions could be, e.g., synchronization signal block, tracking reference signal, or common search space transmissions, data transmission, particularly data for ultra-reliable and low latency communication (URLLC) application. There are various options for determining that a collision takes place. For instance, the UE can execute PRS measurements and based on the PRS measurements determine that the PRS transmission is interfered or missing (i.e., no PRS present). Alternatively or additionally, the BS could indicate the collision by means of a collision indicator that is signaled. For instance, a Layer 1 indication can be provided in a Downlink Control Information (DCI).

In such a case, various actions can be taken to mitigate the collision. For instance, a portion or the entire repetition of the bandlimited PRS transmission 300 can be dropped or postponed in time domain. Muting could be applied (cf. FIG. 7). It would also be possible to rearrange the frequency-hop pattern, e.g., from frequency-ascending order (cf. FIG. 3) to frequency-descending order. In that regard, it is possible that a collision indicator is provided from the BS 111 to the UE 121 or from the LMF 115 to the UE 121. This collision indicator can be indicative of another transmission taking place in the PRBs or REs that have been pre-allocated to the repetitive bandlimited transmission 300. Then, an adjustment of at least one of the timing or the frequency-hop pattern of the repetitive bandlimited transmission 300 can be indicated and executed.

The UE can be explicitly informed of such rearrangement of the frequency hop-pattern. If the UE is not informed of such collision, the UE could also indicate in its measurement report that the measurement is affected or corrupted by the collision. For illustration, at box 5040, when the UE executes the PRS measurement, the UE may at some point decide to drop the PRS measurement, either partly or entirely, for a given sub-band of a given repetition of the bandlimited PRS transmission. This can be responsive to detecting a collision in the respective sub-band. Where the PRS measurement is partly dropped, i.e., some values that are determined based on receive properties of the PRS transmitted in the respective sub-band are used, this could also be indicated in the measurement report.

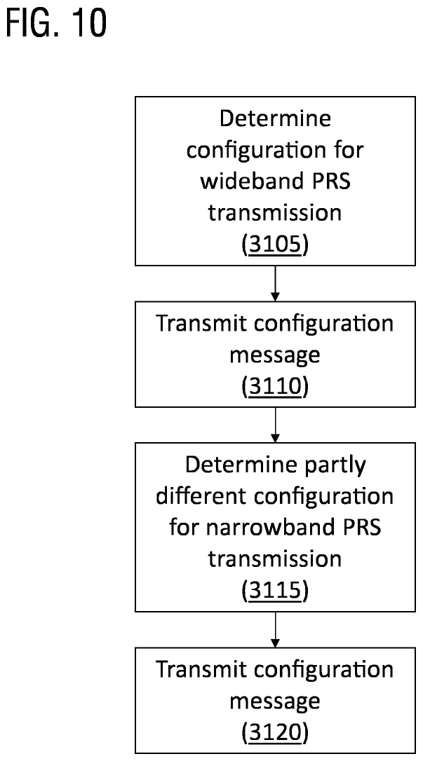

FIG. 10 is a flowchart of a method according to various examples. The method of FIG. 10 can be executed by a wireless communication node such as a BS, e.g., the serving BS of a bandlimited UE. The method of FIG. 10 could be executed by the BS 111. The method of FIG. 10 could be executed by the processor 91 upon loading program code from the memory 92 and upon executing the program code.

The method of FIG. 10 illustrates aspects in connection with obtaining a configuration of a repetitive transmission. More specifically, the method of FIG. 10 illustrates aspects in connection with obtaining configurations for a repetitive bandlimited PRS transmission as well as for a repetitive wideband PRS transmission such as the bandlimited transmission 300 and the wideband transmission 200.

At box 3105, the BS determines a configuration for the wideband PRS transmission. This can include setting values for parameter such as: periodicity; count of resource sets; muting pattern; sequence ID of the PRS; comb structure. Thereby, the BS obtains the configuration.

Then, at box 3110, the BS transmits a respective configuration message that is indicative of the configuration that has been determined at box 3105. The configuration message could be transmitted directly to the UE or through a location management server such as a 3GPP LMF. The UE receives the configuration message and thereby obtains the configuration.

Then, at box 3115, the BS determines a further configuration for the bandlimited PRS transmission. This can be responsive to a need to provide the bandlimited PRS transmission, e.g., because one or more bandlimited UEs have requested positioning.

It is possible that at least one value differs for one or more parameters in between the bandlimited PRS transmission and the wideband PRS transmission. It is also possible that all values differ.

The configuration determined at box 3115 can, furthermore, include the configuration of the frequency-hop pattern. This can include one or more parameters such as: count of sub-bands; frequencies of sub-bands; overlap between sub-bands; time gap in between sub-bands; sequence of sub-bands. In other examples, the configuration of the frequency hop pattern can also be predetermined, e.g., in the communication protocol. In some examples, it would be possible that the frequency-hop pattern is configured by relying on a codebook of candidate frequency-hop patterns. This can be a table of candidate configurations for the frequency-hop pattern in the respective index can then be signaled.

At box 3120, the BS transmits another configuration message that is indicative of the configuration that has been determined at box 3115. For instance, it would be possible that the configuration message only indicates the values of those one or more parameters that differ between the bandlimited transmission and the wideband transmission. Thus, per default, values for the bandlimited PRS transmission can be inherited from the wideband PRS transmission. The configuration message at box 3120 can thus be seen as an “incremental update” of values of one or more parameters using the wideband PRS transmission as reference. This is particularly useful if the bandlimited PRS transmission of the wideband PRS transmission have repetitions that are interleaved in time domain.

Scenarios are conceivable where multiple values of a given parameter differ from sub-band to sub-band. For instance, the number of time-frequency resources—e.g., the comb pattern, the bandwidth, the resource sets or the number of symbols—may vary from sub-band to sub-band. It would also be possible that the frequency offset between adjacent sub-bands is varied. According to examples, it is then possible that the multiple values are indicated by signaling a ruleset that provides, as output, the value for a given subset. The ruleset, accordingly, can be indicative of the variation of the value from submental sub-band. Thereby, instead of signaling all values for all sub-bands, the rule set can be signaled; and the UE can infer of the intended values for each sub-band by applying the rule set. Thereby, control signaling overhead is reduced.

The method of FIG. 10 is only one example of configuring the bandlimited PRS transmission. In some examples, all parameters of the bandlimited PRS transmission may be pre-configured in accordance with a communication protocol. In such a scenario, it is not required to transmit configuration messages. The configuration can be obtained by loading the configuration from a memory. In other examples, preconfigured mappings may exist from values of the wideband PRS transmission to values of the bandlimited PRS transmission; such a case, it may not be required to transmit the configuration message at box 3120, because the UE can infer the respective values of the parameters of the bandlimited PRS transmission from the values of the respective parameters of the wideband PRS transmission, using the mapping.

Summarizing, techniques of positioning a UE using P-RS transmissions have been disclosed. A bandlimited transmission of one or more P-RSs is provided using a frequency-hopping pattern that includes multiple sub-bands. There is an overlap in-between adjacent sub-bands in frequency domain. A time gap is provided in-between adjacent sub-bands, providing time for a receiver of the UE to retune.

Various properties of the bandlimited transmission of one or more P-RSs have been disclosed. For instance, it has been disclosed that the bandwidth of the sub-bands of the frequency-hopping pattern can be configured, e.g., by a BS. Alternatively, it would also be possible that the bandwidth of the sub-bands are static, e.g., predefined in accordance with the communication protocol. It has been disclosed that a bandlimited transmission of one or more PRSs can complement/coexist with a wideband transmission of one or more PRSs. This means that multiple repetitions of the bandlimited transmission can be interleaved in time domain with multiple repetitions of the wideband transmission.

Techniques have been disclosed that allow to mute individual repetitions of a bandlimited transmission of PRSs.

According to examples, details with respect to the frequency-hopping operation have been disclosed. For instance, details with respect to the frequency arrangement or specifically the starting frequency of the sub-bands of the frequency-hopping pattern have been disclosed. For instance, the frequencies could be fixed or could be configurable, e.g., by the BS. The indexing of the sub-bands of the frequency-hopping pattern have been disclosed. Techniques have been disclosed that enable to flexibly reconfigure a frequency-hopping pattern, to thereby avoid collisions with further transmissions.

Details with respect to the overlap in frequency domain in-between adjacent sub-bands of the frequency-hopping pattern have been disclosed. For instance, the amount of overlap can be configured and/or can be a function of the configuration of the bandlimited transmission or the PRSs, e.g., can be a function of the comb size.

Aspects with respect to collision handling for the bandlimited transmission of one or more PRSs have been disclosed.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For instance, various examples have been disclosed in the context of an example where downlink PRSs are employed for positioning a UE. The techniques described herein can be likewise applied to uplink P-RSs transmitted by a UE and received by multiple BSs, e.g., UL SRS. In such a case, the measurement reports are not provided by the UE to a location management server; but, rather, the measurement reports are provided by the BSs that receive the uplink positioning reference signals.

1. A method of operating a wireless communication node, the method comprising:
obtaining a configuration of a repetitive transmission of one or more reference signals for positioning of a wireless terminal connectable to a communications network via an access node using a wireless carrier, the configuration comprising a frequency-hop pattern for the repetitive transmission, the frequency-hop pattern comprising multiple sub-bands of a carrier band of the wireless carrier, the multiple sub-bands being pairwise partly overlapping in frequency domain,
wherein multiple repetitions of the repetitive transmission are interleaved in time domain with multiple repetitions of a further repetitive transmission of the one or more reference signals, the further repetitive transmission being on a wideband that has a larger bandwidth than each one of the multiple sub-bands.

2. The method of claim 1,
wherein the configuration specifies whether one or more of the multiple repetitions of the repetitive transmission are muted.

3. The method of claim 2,
wherein the configuration comprises a repetitive muting pattern that specifies a periodicity of said muting of the repetitions of the repetitive transmission.

4. The method of claim 2,
wherein the configuration comprises an aperiodic muting command that specifies individual ones of the repetitions of the repetitive transmission to be muted.

5. The method of claim 1,
wherein the configuration specifies one or more time gaps in-between parts of the repetitive transmission on neighboring ones of the multiple sub-bands, and/or
wherein the configuration specifies a further time gap in-between the further repetitive transmission and the repetitive transmission.

6. The method of claim 1, the method comprising:
obtaining a further configuration of the further repetitive transmission.

7. A method of operating a wireless communication node, the method comprising:
obtaining a configuration of multiple repetitive transmissions of one or more reference signals for positioning of a wireless terminal connectable to a communications network via an access node using a wireless carrier, the configuration comprising a frequency-hop pattern for the multiple repetitive transmissions, the frequency-hop pattern comprising, for a first repetitive transmission of the multiple repetitive transmissions, multiple sub-bands of a carrier band that are pairwise partly overlapping in frequency-domain and further comprising, for a second repetitive transmission of the multiple repetitive transmissions, a wideband that has a larger bandwidth than each one of the multiple sub-bands.

8. A method of operating a wireless terminal connectable to a communications network via an access node using a wireless carrier, the method comprising:
obtaining a configuration of a repetitive transmission of one or more reference signals for positioning of the wireless terminal, the configuration being indicative of multiple sub-bands of a carrier band of the wireless carrier that are pairwise partly overlapping in frequency-domain and further indicative of a wideband that has a larger bandwidth than each one of the multiple sub-bands, and
based on the configuration: monitoring for the one or more reference signals in at least one of the multiple sub-bands and further in a bandlimited fraction of the wideband.

9. The method of claim 8,
wherein the bandlimited fraction of the wideband overlaps with one or more of the at least one of the multiple sub-bands.

10-32. (canceled)
